(19) United States
(12) Patent Application Publication
(10) Pub. No.: US 2026/0302305 A1
(43) Pub. Date: Oct. 1, 2026

(54) FUEL CELL STACK

(71) Applicant: HONDA MOTOR CO., LTD., TOKYO (JP)

(72) Inventors: Naoki INOUE, WAKO-SHI (JP); Tomoki HORI, WAKO-SHI (JP); Yu YAMAGUCHI, WAKO-SHI (JP); Tadashi NISHIYAMA, WAKO-SHI (JP)

(21) Appl. No.: 19/578,492

(22) Filed: Mar. 25, 2026

(30) Foreign Application Priority Data
Mar. 28, 2025 (JP) 2025-056316

(51) Int. Cl. H01M 8/2484; H01M 8/0206; H01M 8/0258; H01M 8/0267; H01M 8/0271; H01M 8/04029

(52) U.S. Cl. CPC H01M 8/2484; H01M 8/0206; H01M 8/0258; H01M 8/0267; H01M 8/0271; H01M 8/04029

(57) ABSTRACT

A fuel cell stack includes a resin insulator molded on each of a pair of end plates. Each of the pair of end plates includes a convex part protruding from a cell-side end surface of a base part. The resin insulator includes a base part covering portion covering at least a part of the cell-side end surface, and a convex part covering portion covering the convex part. The convex part covering portion includes a flat portion. A bead seal of a metal separator constituting a unit cell abuts against the flat portion.

### CROSS-REFERENCE TO RELATED APPLICATIONS

This application is based upon and claims the benefit of priority from Japanese Patent Application No. 2025-056316 filed on Mar. 28, 2025, the contents of which are incorporated herein by reference.

### BACKGROUND OF THE INVENTION

### FIELD OF THE INVENTION

The present disclosure relates to a fuel cell stack.

### DESCRIPTION OF THE RELATED ART

A fuel cell stack includes a cell stack body in which unit cells are stacked, and a pair of end plates disposed at both ends of the cell stack body in a stacking direction. In general, a pair of insulating plates are interposed between the cell stack body and the pair of end plates, respectively. JP 2020-107551 A discloses a structure in which a metal plate is further interposed between a bead seal of a metal separator constituting a unit cell and an insulating plate.

### SUMMARY OF THE INVENTION

In order to lighten the fuel cell stack as much as possible, it is considered to omit the metal plates. In this case, a fastening load when the fuel cell stack is tightened acts on the insulating plates. The insulating plates may be deformed due to the fastening load.

The present disclosure has the object of solving the aforementioned problem.

An aspect of the present disclosure is characterized by a fuel cell stack provided with a cell stack body including a plurality of unit cells, a pair of end plates sandwiching the cell stack body in a stacking direction of the cell stack body, the pair of end plates being made of a metal material, and a resin insulator molded on a surface of each of the pair of end plates facing toward the cell stack body,wherein each of the pair of end plates includes a base part and a convex part protruding from a cell-side end surface of the base part facing toward the cell stack body, and the convex part includes a top surface having a flat shape,the resin insulator includes a base part covering portion configured to cover at least a part of the cell-side end surface and a convex part covering portion configured to cover the convex part,the convex part covering portion includes a flat portion configured to cover the top surface and facing toward the cell stack body,a metal separator constituting each of the unit cells includes a bead seal having a ridge shape protruding toward the cell-side end surface, andthe bead seal abuts against the flat portion.

According to the present disclosure, deformation of the resin insulator is suppressed. Therefore, a suitable seal is provided between the cell stack body and each of the pair of end plates.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic overall perspective view of a fuel cell stack according to an embodiment of the present disclosure;

FIG. 2 is an exploded perspective view of a unit cell constituting a cell stack body;

FIG. 3 is a schematic overall perspective view of an end plate as viewed from the inside in a stacking direction;

FIG. 4 is a schematic overall perspective view of an end plate with a resin insulator molded therein, as viewed from the inside in the stacking direction; and

FIG. 5 is a cross-sectional view taken along line V-V of FIG. 4.

### DETAILED DESCRIPTION OF THE INVENTION

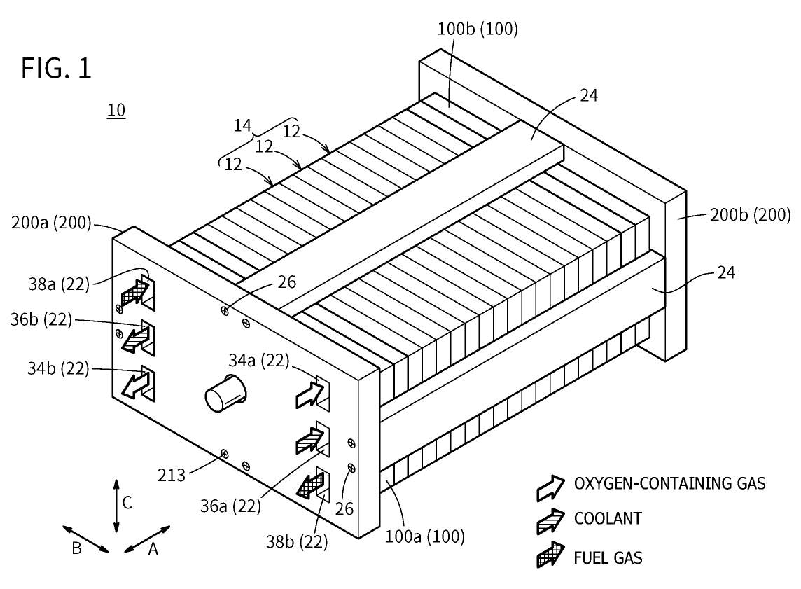

FIG. 1 is a schematic overall perspective view illustrating a fuel cell stack 10 according to the present embodiment. The fuel cell stack 10 includes a cell stack body 14 including a plurality of unit cells 12, and a pair of end plates 200. The pair of end plates 200 includes a first end plate 200a and a second end plate 200b. The first end plate 200a and the second end plate 200b sandwich the cell stack body 14 in the stacking direction of the cell stack body 14. That is, the pair of end plates 200 are disposed on the outer side in the stacking direction of the cell stack body 14.

Ends of connecting bars 24 in the longitudinal direction are connected to the first end plate 200a via a plurality of connecting bolts 26. Other ends of the connecting bars 24 in the longitudinal direction are connected to the second end plate 200b via a plurality of connecting bolts 26. As described above, the first end plate 200a and the second end plate 200b are connected to each other via the connecting bars 24. A casing may be connected to the pair of end plates 200 instead of the connecting bars 24.

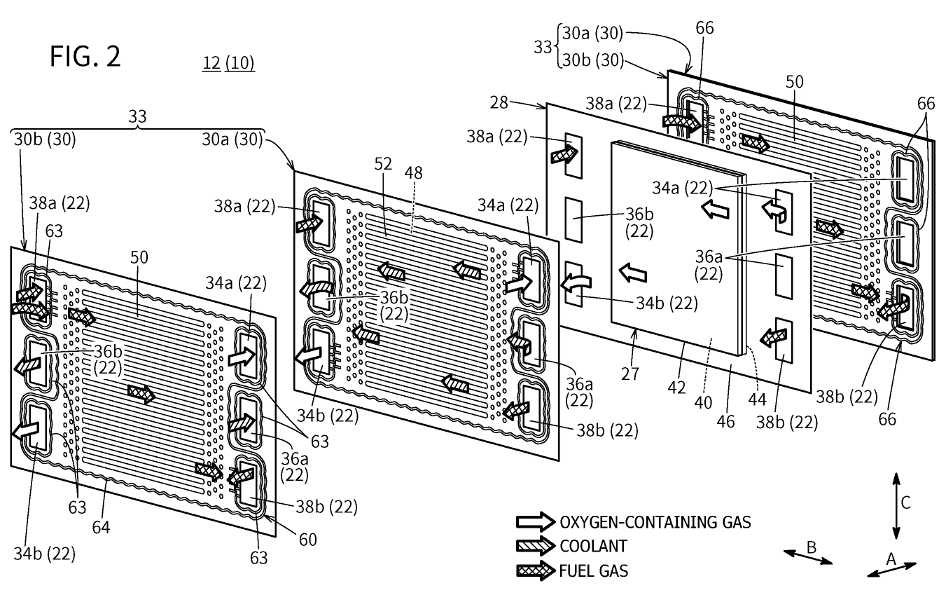

As shown in FIG. 2, the unit cell 12 includes a framed MEA 28 formed by supporting a membrane electrode assembly (MEA) 27 with a resin frame 46, and a pair of metal separators 30 (a first separator30a and a second separator 30b) sandwiching the framed MEA 28 from both sides. The MEA 27 has an electrolyte membrane 40, and an anode 44 and a cathode 42 formed on both end surfaces of the electrolyte membrane 40, respectively.

The first separator 30a and the second separator 30b are formed, for example, by press forming of a steel sheet, a stainless steel sheet, an aluminum sheet, a plated steel sheet, or a thin metal sheet subjected to an anti-corrosive surface treatment on the metal surface thereof, into a shape having a corrugated cross section. The first separator 30a and the second separator 30b are joined together integrally by welding, soldering, or crimping the outer peripheries thereof to thereby constitute a joined separator 33.

As shown in FIG. 1, the cell stack body 14 includes a pair of dummy cells 100. However, it is not essential that the cell stack body 14 includes the pair of dummy cells 100. For example, the cell stack body 14 may be configured only by the unit cells 12. In this case, in the cell stack body 14, the unit cells 12 located at both ends in the stacking direction face a resin insulator 250 described later.

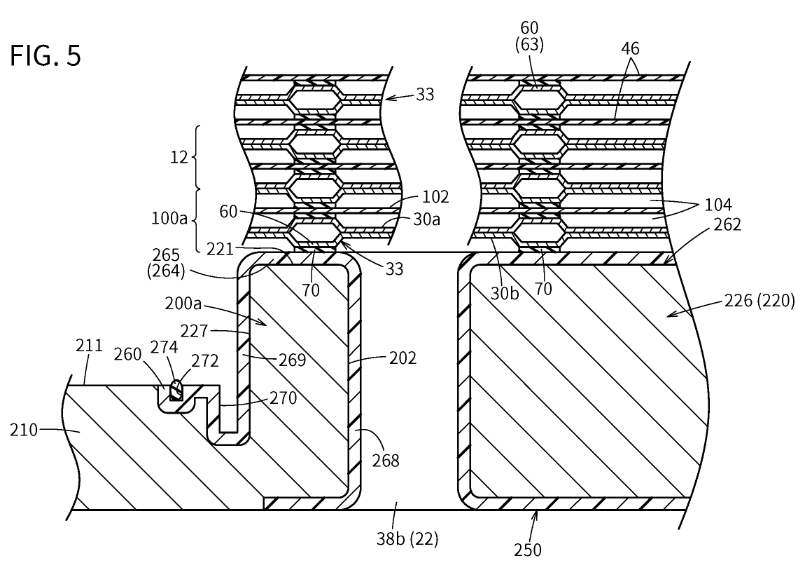

The pair of dummy cells 100 includes a first dummy cell 100a and a second dummy cell 100b. The first dummy cell 100a and the second dummy cell 100b are disposed at both ends of the cell stack body 14 in the stacking direction. As shown in FIG. 5, the first dummy cell 100a is formed by sandwiching a metal plate 102 between a pair of joined separators 33. As described above, the first dummy cell 100a has a configuration in which the framed MEA 28 of the unit cell 12 is replaced with the metal plate 102. The same applies to the second dummy cell 100b. The first dummy cell 100a and the second dummy cell 100b are not involved in power generation.

In each of the first dummy cell 100a and the second dummy cell 100b, a space 104 is formed between each of the pair of joined separators 33 and the metal plate 102. The space 104 functions as a heat insulation portion that blocks heat transfer.

As shown in FIG. 2, the first separator 30a and the second separator 30b have bead seals 60 in the form of ridges protruding toward cell-side end surfaces 211 of the first end plate 200a and the second end plate 200b, respectively. The first separator 30a and the second separator 30b further include bead seals 66 in the form of ridges protruding toward the resin frame 46, but the bead seals 66 will not be described.

The bead seals 60 are formed so as to bulge from both end surfaces in the thickness direction of the first separator 30a or the second separator 30b when the first separator 30a or the second separator 30b is produced by press forming. The bead seals 60 each includes a plurality of passage sealing members 63 surrounding a plurality of passages 22 (described later), and an annular outer periphery sealing member 64 along the outer edge of the first separator 30a or the second separator 30b.

As shown in FIG. 1, the pair of end plates 200 are disposed outside the pair of dummy cells 100 in the stacking direction. The pair of end plates 200 are made of a metal material.

As shown in FIGS. 1 and 2, the fuel cell stack 10 has the plurality of passages 22. Each of the openings of the plurality of passages 22 is formed in the first end plate 200a. In the illustrated example, the plurality of passages 22 include a fuel gas supply passage 38a, an oxygen-containing gas supply passage 34a, and a coolant supply passage 36a. The plurality of passages 22 include a fuel gas discharge passage 38b, an oxygen-containing gas discharge passage 34b, and a coolant discharge passage 36b.

In the illustrated example, at one end of the fuel cell stack 10 in the widthwise direction, the oxygen-containing gas discharge passage 34b, the coolant discharge passage 36b, and the fuel gas supply passage 38a are arranged in the direction of the arrow C. At another end of the fuel cell stack 10 in the widthwise direction, the fuel gas discharge passage 38b, the coolant supply passage 36a, and the oxygen-containing gas supply passage 34a are arranged in the direction of the arrow C. However, the above is but one example.

The plurality of passages 22 extend along the stacking direction. In the fuel cell stack 10, the reaction gases (the oxygen-containing gas and the fuel gas) and the coolant flow in the stacking direction and are respectively distributed to the unit cells 12 through the oxygen-containing gas flow fields 48, the fuel gas flow fields 50, and the coolant flow fields 52 formed in the joined separators 33.

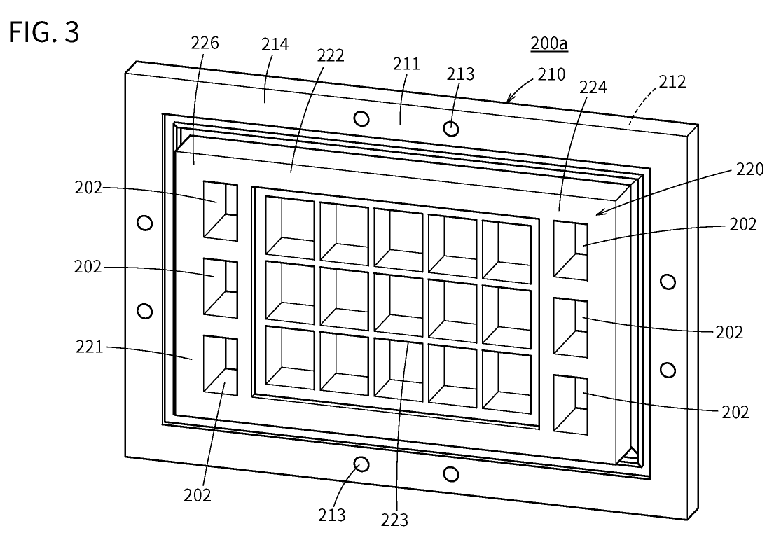

FIG. 3 is a schematic overall perspective view of the first end plate 200a as viewed from the inside in the stacking direction. The first end plate 200a has a base part 210. The base part210 has the cell-side end surface 211 facing the cell stack body 14 and an outer end surface 212 which is a back surface of the cell-side end surface 211. The outer end surface 212 faces outward in the stacking direction of the cell stack body 14.

The first end plate 200a has a convex part 220 protruding from the cell-side end surface 211 toward the cell stack body 14. The convex part 220 includes an annular outer frame portion 222 that extends along four sides of the first end plate 200a and a rib portion 223 that is formed in a lattice shape inside the outer frame portion 222. The convex part 220 further includes a first passage surrounding portion 224 that is one end portion in the widthwise direction orthogonal to the stacking direction and is located between the outer frame portion 222 and the rib portion 223, and a second passage surrounding portion 226 that is another end portion in the widthwise direction and is located between the outer frame portion 222 and the rib portion 223.

The first end plate 200a has a plurality of through holes 202. As shown in FIG. 5, the inner surfaces of the plurality of through holes 202 are covered with inner surface covering portions 268, whereby the plurality of passages 22 are formed.

As shown in FIG. 3, the first passage surrounding portion 224 surrounds three of the plurality of through holes 202. The three through holes 202 correspond to the oxygen-containing gas discharge passage 34b, the coolant discharge passage 36b, and the fuel gas supply passage 38a, respectively. The second passage surrounding portion 226 surrounds the remaining three of the plurality ofthrough holes 202. The three through holes 202 correspond to the fuel gas discharge passage 38b, the oxygen-containing gas supply passage 34a, and the coolant supply passage 36a, respectively. In the convex part 220, a top surface 221 facing the cell stack body 14 is parallel to the cell-side end surface 211 of the base part210 and is flat. The top surface 221 is a surface orthogonal to the stacking direction of the cell stack body 14.

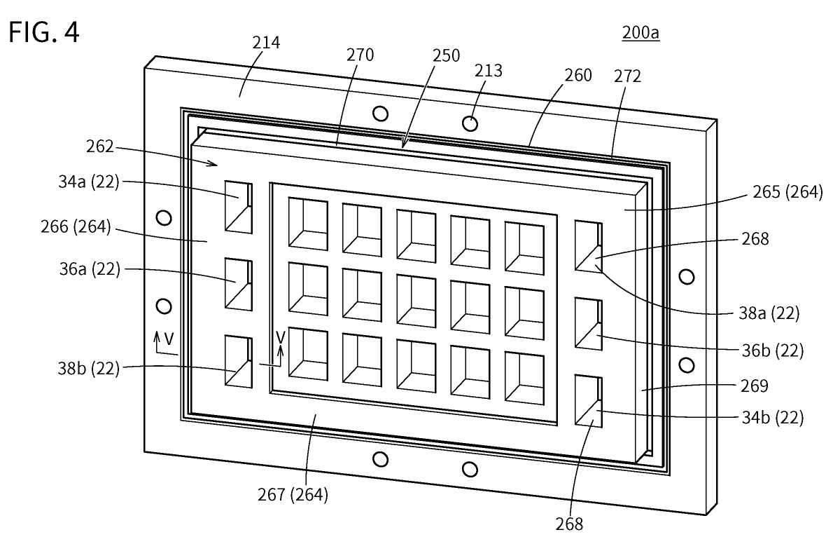

As shown in FIG. 4, the fuel cell stack 10 further includes resin insulators 250 molded on the pair of end plates 200. In other words, each of the end plates 200 and the resin insulator 250 are integrally molded.

The resin insulator 250 includes a base part covering portion 260 and a convex part covering portion 262. The base part covering portion 260 covers at least a part of the cell-side end surface 211 of the base part210. FIG. 4 illustrates an aspect in which a peripheral edge portion 214 including a plurality of bolt holes 213 is not covered with the base part covering portion 260 in each of the end plates 200. The plurality of bolt holes 213 are holes through which the connecting bolts 26 shown in FIG. 1 pass.

As shown in FIG. 4, the convex partcovering portion 262 covers the rib portion 223 and covers the entire flat top surface 221 of the convex part 220. The convex partcovering portion 262 has a flat portion 264 facing the cell stack body 14. The flat portion 264 includes a first passage surrounding flat portion 265 covering the first passage surrounding portion 224, a second passage surrounding flat portion 266 covering the second passage surrounding portion 226, and an outer frame flat portion 267 covering the outer frame portion 222.

As shown in FIG. 5, which is a cross-sectional view taken along line V-V in FIG. 4, in the first dummy cell 100a, the passage sealing members 63 of the bead seal 60 on the second separator 30b of the joined separators 33 are in contact with the first passage surrounding flat portion 265 and the second passage surrounding flat portion 266. On the other hand, the outer periphery sealing member 64 of the bead seal 60 on the second separator 30b abuts against the outer frame flat portion 267.

As understood from FIG. 5, the plurality of passage sealing members 63 abut against the first passage surrounding flat portion 265 and the second passage surrounding flat portion 266 via micro seals 70. Each of the micro seals 70 is a seal formed by curing a resin. Therefore, the passage sealing members 63 are joined to the first passage surrounding flat portion 265 and the second passage surrounding flat portion 266 via the micro seals 70. Although not shown, the outer periphery sealing member 64 similarly abuts against the outer frame flat portion 267 via the micro seal 70.

The first passage surrounding flat portion 265 is continuous with an inner surface covering portion 268 that covers the inner surface of the through hole 202 and an outer surface covering portion 269 that covers an outer side surface 227 of the convex part 220. The inner surface covering portion 268 and the outer surface covering portion 269 are parts of the resin insulator 250. The inner surface of the through hole 202 is covered with the inner surface covering portion 268, thereby forming the passage 22. In FIG. 5, the fuel gas discharge passage 38b is shown as an example of the passage 22.

In the present embodiment, the resin insulator 250 has an annular groove 270 and a seal accommodation groove 272. However, it is not essential that the resin insulator 250 has the annular groove 270 and the seal accommodation groove 272.

The annular groove 270 is a groove for increasing a creepage distance in the resin insulator 250. That is, since the resin insulator 250 has the annular groove 270, the insulation performance of the resin insulator 250 is increased as compared with the case where the annular groove 270 is not present.

The seal accommodation groove 272 is formed at a position surrounding the outer periphery of the annular groove 270. The seal accommodation groove 272 is a groove for accommodating (inserting) an annular sealing member 274. The sealing member 274 seals between the cell stack body 14 and the first end plate 200a.

The relationship among the second end plate 200b, the resin insulator 250 molded on the second end plate 200b, and the first separator 30a of the second dummy cell 100b is substantially the same as the above. Therefore, the second end plate 200b, the resin insulator 250, and the second dummy cell 100b will not be shown or described in detail.

The fuel cell stack 10 basically configured as described above, for example, is mounted in a fuel cell vehicle such as a fuel cell electric vehicle (not shown).

Next, operations of the fuel cell stack 10, which is constructed in the foregoing manner, will be described.

First, as shown in FIG. 1, an oxygen-containing gas, for example, air or the like, is supplied to the oxygen-containing gas supply passage 34a of the first end plate 200a. A fuel gas such as a hydrogen-containing gas or the like is supplied to the fuel gas supply passage 38a of the first end plate 200a. Further, a coolant such as pure water, ethylene glycol, or oil is supplied to the coolant supply passage 36a of the first end plate 200a.

As shown in FIG. 2, the oxygen-containing gas is introduced from the oxygen-containing gas supply passage 34a to the oxygen-containing gas flow field 48 of the first separator 30a, and supplied to the cathode 42 of the MEA 27. On the other hand, the fuel gas is introduced from the fuel gas supply passage 38a to the fuel gas flow field 50 of the second separator 30b, and supplied to the anode 44 of the MEA 27. In the MEA 27, the oxygen-containing gas and the fuel gas are partially consumed by way of electrochemical reactions to generate electric power.

An excess amount of the oxygen-containing gas supplied to the cathode 42 is discharged along the oxygen-containing gas discharge passage 34b in the direction of the arrow A. Similarly, an excess amount of the fuel gas supplied to the anode 44 is discharged along the fuel gas discharge passage 38b in the direction of the arrow A.

Further, the coolant that is supplied to the coolant supply passage 36a is introduced into the coolant flow field 52 formed between the first separator 30a and the second separator 30b, and thereafter, the coolant flows in the direction of the arrow B. After the coolant has cooled the MEA 27, the coolant is discharged from the coolant discharge passage 36b.

The fuel cell stack 10 according to the present embodiment exhibits the following advantageous effects.

As shown in FIGS. 4 and 5, the resin insulator 250 is molded on the first end plate 200a made of metal. Therefore, the resin insulator 250 is reinforced by the first end plate 200a. Accordingly, the resin insulator 250 is prevented from being deformed. As a result, a suitable seal is provided between the cell stack body 14 and the first end plate 200a.

In addition, in the first end plate 200a made of metal, the flatness of the top surface 221 of the convex part 220 can be increased. Therefore, a part of the convex partcovering portion 262 covering the convex part 220 can be provided as the flat portion 264 having high flatness. Therefore, the passage sealing members 63 favorably abut against the first passage surrounding flat portion 265 and the second passage surrounding flat portion 266, and the outer periphery sealing member 64 favorably abuts against the outer frame flat portion 267, so that good sealing performance is provided between the resin insulator 250 and the second separator 30b.

For the same reason, the good sealing performance is also provided between the resin insulator 250 molded on the second end plate 200b and the first separator 30a.

The base part covering portion 260 of the resin insulator 250 has the annular groove 270. In the case where the annular groove 270 is present, the creepage distance is longer than in the case where the annular groove 270 is not present. Therefore, the insulation performance of the resin insulator 250 is improved.

The base part covering portion 260 has the seal accommodation groove 272 surrounding the outer periphery of the annular groove 270. The sealing member 274 is accommodated in the seal accommodation groove 272. The sealing member 274 prevents the fluid (the reaction gas or the coolant) from leaking to the outside from the bead seal 60. Also, the sealing member 274 prevents moisture, foreign substance, or the like from entering the cell stack body 14 from the outside of the fuel cell stack 10.

The first end plate 200a has the plurality of passages 22 through which reactant gases (fuel gas and oxygen-containing gas) and a coolant flow. The flat portion 264 includes the first passage surrounding flat portion 265 and the second passage surrounding flat portion 266 that surround the plurality of passages 22. The plurality of passage sealing members 63 of the bead seal 60 abut against the first passage surrounding flat portion 265 and the second passage surrounding flat portion 266, respectively, so that the outer peripheries of the plurality of passages 22 are sealed suitably.

The cell stack body 14 includes the pair of dummy cells 100 (the first dummy cell 100a and the second dummy cell 100b) that are located at both ends of the cell stack body 14 in the stacking direction and are not involved in power generation. Each of the first dummy cell 100a and the second dummy cell 100b has the pair of metal separators 30 having the bead seals 60. The bead seal 60 of the metal separator 30 on each of the first dummy cell 100a and the second dummy cell 100b abuts against the flat portion 264 of the resin insulator 250.

In the first dummy cell 100a, the heat transfer is blocked by the space 104 formed between the metal plate 102 and each of the pair of joined separators 33. Therefore, the temperature of both ends of the cell stack body 14 can be kept well.

The bead seal 60 abuts against the flat portion 264 via the micro seal 70. Therefore, the sealing performance between the bead seal 60 and the flat portion 264 is further improved.

The following supplementary notes are further disclosed in relation to the above embodiment.

### Supplementary Note 1

The fuel cell stack (10) according tothe present disclosure includes the cell stack body (14) including the plurality of unit cells (12), the pair of end plates (200) sandwiching the cell stack body in the stacking direction of the cell stack body, the pair of end plates being made of a metal material, and the resin insulator (250) molded on the surface of each of the pair of end plates facing toward the cell stack body, wherein each of the pair of end plates includes the base part (210) and the convex part (220) protruding from the cell-side end surface (211) of the base part facing toward the cell stack body, and the convex part includes the top surface (221) having the flat shape, the resin insulator includes the base part covering portion (260) configured to cover at least a part of the cell-side end surface and the convex part covering portion (262) configured to cover the convex part,the convex part covering portion includes the flat portion (264) configured to cover the top surface and facing toward the cell stack body, the metal separator (30) constituting each of the unit cells includes the bead seal (60) having the ridge shape protruding toward the cell-side end surface, andthe bead seal abuts against the flat portion.

In the fuel cell stack described above, the resin insulator is molded to each of the end plates made of metal. Therefore, the resin insulator is reinforced by each of the end plates. Therefore, the resin insulator is prevented from being deformed. In accordance with this configuration, a suitable seal is provided between the cell stack body and each of the pair of end plates.

Further, since each of the end plates is made of a metal material, the flatness of the top surface of the convex part can be increased. Therefore, the convex part covering portion covering the convex part can be provided with the flat portion having high flatness.

### Supplementary Note 2

In the fuel cell stack according toSupplementary Note 1, the base part covering portion may include the annular groove (270).

In this case, the annular groove increases the creepage distance of the resin insulator, and thus the insulation performance of the resin insulator is improved.

### Supplementary Note 3

In the fuel cell stack according to Supplementary Note 2, the base part covering portion may include the seal accommodation groove (272) that surrounds an outer periphery of the annular groove and into which the sealing member (274) is inserted.

The sealing member is accommodated in the seal accommodation groove, whereby a fluid (the reaction gas or the coolant) is prevented from leaking from the bead seal to the outside of the fuel cell stack. In addition, moisture, foreign substance, or the like is prevented from entering the inside of the cell stack body from the outside of the fuel cell stack.

### Supplementary Note 4

In the fuel cell stack according to any one of Supplementary Notes 1 to 3, one of the pair of end plates may include the plurality of passages (22) through which the reaction gas and the coolant flow, and the flat portion may be provided at the position surrounding the plurality of passages.

In this case, the outer peripheries of the passages can be sealed well.

### Supplementary Note 5

In the fuel cell stack according to any one of Supplementary Notes 1 to 4, the cell stack body may include the pair of dummy cells (100) that are located at both ends of the cell stack body in the stacking direction and are not involved in power generation,each of the pair of dummy cells may include the metal separator (30) including the bead seal (60), andthe bead seal of the metal separator in each of the pair of dummy cells may abut against the flat portion.

Since the space is formed inside each of the pair of dummy cells, the space is formed at each end of the cell stack body. This space can keep each end of the cell stack body warm well.

### Supplementary Note 6

In the fuel cell stack according to any one of Supplementary Notes 1 to 5, the bead seal may abut against the flat portion via the micro seal (70).

The sealing performance between the bead seal and the flat portion is further improved by the micro seal.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the purpose and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. Further, the same also applies to cases in which numerical values or mathematical expressions are used in the description of the aforementioned embodiments.

1. A fuel cell stack comprising: a cell stack body including a plurality of unit cells; a pair of end plates sandwiching the cell stack body in a stacking direction of the cell stack body, the pair of end plates being made of a metal material; and a resin insulator molded on a surface of each of the pair of end plates facing toward the cell stack body,
wherein each of the pair of end plates includes a base part and a convex part protruding from a cell-side end surface of the base part facing toward the cell stack body, and the convex part includes a top surface having a flat shape,
the resin insulator includes a base part covering portion configured to cover at least a part of the cell-side end surface and a convex part covering portion configured to cover the convex part,
the convex part covering portion includes a flat portion configured to cover the top surface and facing toward the cell stack body,
a metal separator constituting each of the unit cells includes a bead seal having a ridge shape protruding toward the cell-side end surface, and
the bead seal abuts against the flat portion.

2. The fuel cell stack according to claim 1, wherein the base part covering portion includes an annular groove.

3. The fuel cell stack according to claim 2, wherein the base part covering portion includes a seal accommodation groove that surrounds an outer periphery of the annular groove and into which a sealing member is inserted.

4. The fuel cell stack according to claim 1, wherein one of the pair of end plates includes a plurality of passages through which a reaction gas and a coolant flow, and the flat portion is provided at a position surrounding the plurality of passages.

5. The fuel cell stack according to claim 1, wherein the cell stack body includes a pair of dummy cells that are located at both ends of the cell stack body in the stacking direction and are not involved in power generation,
each of the pair of dummy cells includes a metal separator including a bead seal, and
the bead seal of the metal separator in each of the pair of dummy cells abuts against the flat portion.

6. The fuel cell stack according to claim 1, wherein the bead seal abuts against the flat portion via a micro seal.
